(19) United States
(12) Patent Application Publication
(10) Pub. No.: US 2010/0107090 A1
(43) Pub. Date: Apr. 29, 2010

(54) REMOTE LINKING TO MEDIA ASSET GROUPS

(76) Inventors: Camille Hearst, San Francisco, CA (US); Garrick McFarlane, Yeovil (GB); Mufaddal Khumri, Campbell, CA (US); Neale Patton, Twickenham (GB); Payam Mirrashidi, San Francisco, CA (US); Mark Miller, San Francisco, CA (US); Ellis M. Verosub, San Carlos, CA (US)

Correspondence Address: TECHNOLOGY & INNOVATION LAW GROUP, PC, ATTN: 101, 19200 STEVENS CREEK BLVD., SUITE 240, CUPERTINO, CA, 95014, US

(21) Appl. No.: 12/259,297

(22) Filed: Oct. 27, 2008

(51) Int. Cl. G06F 3/048

(52) U.S. Cl. 715/760

(57) ABSTRACT

Improved approaches to access information concerning media asset groups are disclosed. In one embodiment, a first web page can include a user-selectable control that, upon selection, can request information on a particular media asset group from a remote media asset web server. In response to the request, the remote media asset web server can return a second web page containing the information on the particular media asset group.

### BACKGROUND OF THE INVENTION

1. Field of the Invention

The present invention relates to accessing information pertaining to a group of products and, more particularly, to remotely accessing information on a media asset group.

2. Description of the Related Art

Conventionally, a playlist of audio tracks can be formed. For example, a media management and playback program, such as iTunes®™ from Apple Inc. of Cupertino, Calif. can be used to form a playlist of audio tracks and then play the audio tracks in the playlist as desired. However, it is also possible to form a playlist of audio tracks even though the audio tracks are not available for playback. For example, a user can access a website that has provided a playlist. The playlist can be a list of audio tracks that are to be played or that were played at an event (e.g., party, show, club, etc.). Unfortunately, however, such websites offering the playlists are often not eligible to distribute or play such audio tracks. While some websites have recently been able to assist users in purchasing individual audio tracks, there is no convenient and efficient solution to facilitate acquisition of custom playlists of audio tracks.

Thus, there is a need to facilitate access to information on media assets that are included in consumer customized playlists.

### SUMMARY OF THE INVENTION

The invention pertains to improved techniques to access information concerning media asset groups. In one embodiment, a first web page can include a user-selectable control that, upon selection, can request information on a particular media asset group from a remote media asset web server. In response to the request, the remote media asset web server can return a second web page containing the information on the particular media asset group.

The invention can be implemented in numerous ways, including as a method, system, device, apparatus (including computer readable medium and graphical user interface). Several embodiments of the invention are discussed below.

As a computer-implemented method for linking into a website, one embodiment of the invention can, for example, include at least: identifying a set of digital media assets to be contained in a media asset group; determining media asset identifiers for the digital media assets within the set of digital media assets; providing a title and a description for the media asset group; forming a link to a media repository, the link including at least the title, the description and the media asset identifiers for the media asset group; presenting a web page including at least a first graphical user interface control having the link associated thereto; receiving a user selection of the first graphical user interface control on the web page; accessing a remote server using the link when the graphical user interface control is selected; parsing the link of the remote server to obtain attributes of the media asset group; processing the attributes to provide a media asset group web page pertaining primarily to the media asset group; and presenting the media asset group web page, the media group web page providing a second graphical user interface control that facilitates acquisition of the digital media assets within the media asset group from the media repository.

As a computer-implemented method for accessing a media asset group on a client device, one embodiment of the invention can, for example, include at least: obtaining a first web page from a first web site; presenting the first web page, the first web page including at least a first user-selectable control having a URL request associated thereto; receiving a user selection of the first user-selectable control; issuing the URL request to a second web site for a media asset group web page; receiving the media asset group web page; and presenting the media asset group web page at the client device.

As a computer-implemented method for providing access to a media asset group web page, one embodiment of the invention can, for example, include at least: receiving a media asset group request from a requesting client device; parsing the media asset group request to obtain attributes of the media asset group; processing the attributes of the media asset group to produce a media asset group web page; and sending the media asset group web page to the requesting client device.

As a method for forming a request URL for accessing a media asset group from a media repository, one embodiment of the invention can, for example, include at least: providing a title and/or a description for the media asset group; identifying a plurality of media assets to be included in the media asset group; obtaining an asset identifier for each of the plurality of media assets to be included in the media asset group, the asset identifiers being unique identifiers with respect to media assets maintained by the media repository; and forming the request URL from a base URL together with at least (i) the title and/or description, and (ii) the asset identifiers for the plurality of media assets to be included in the media asset group.

Other aspects of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like elements, and in which:

FIG. 1 is a block diagram of a media system according to one embodiment of the invention.

FIG. 2 is a block diagram of a media asset web server according to one embodiment of the invention.

FIG. 3 illustrates an exemplary configuration for a request URL in accordance with one embodiment of the invention.

FIGS. 4A and 4B are flow diagrams of a client-side media access process according to one embodiment of the invention.

FIG. 5 is a flow diagram of a server-side media access process according to one embodiment of the invention.

FIGS. 6A and 6B are flow diagrams of a media asset group acquisition process according to one embodiment of the invention.

### DETAILED DESCRIPTION OF THE INVENTION

The invention pertains to improved techniques to access information concerning media asset groups. In one embodiment, a first web page can include a user-selectable control that, upon selection, can request information on a particular media asset group from a remote media asset web server. In response to the request, the remote media asset web server can return a second web page containing the information on the particular media asset group.

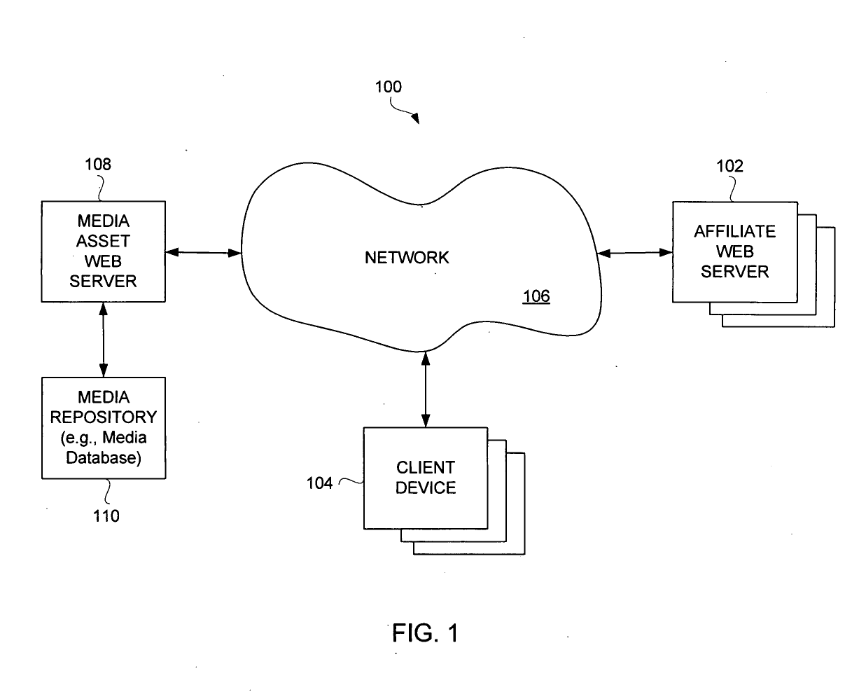

Embodiments of the invention are discussed below with reference to FIGS. 1-6B. However, those skilled in the art will readily appreciate that the detailed description given herein with respect to these figures is for explanatory purposes as the invention extends beyond these limited embodiments.

FIG. 1 is a block diagram of a media system 100 according to one embodiment of the invention. The media system 100 includes one or more affiliate web servers 102 that can be accessed by one or more client devices 104. The client device 104 can operate an application program, such as a media management and playback application (e.g., iTunes™) or a network browser (e.g., FireFox, Safari, Internet Explorer), to access the affiliate web server 102 via a network 106. The network 106 is, for example, a wide area network, a global network, or a local area network. The network 106 can include wired or wireless networks. The client device 104 is a computing device that can couple to the network 106 in a wired or wireless manner. The computing device can pertain to a computer (e.g., notebook computer, desktop computer, ultra-portable computer), personal digital assistant, mobile telephone with program capability, etc.

A user of the client device 104 can interact with an operating application program to access the affiliate web server 102. Typically, when the client device 104 accesses the affiliate web server 102, a web page can be presented on a display device associated with the client device 104. The web page (affiliate web page) can provide a media asset group. As an example, a media asset group can be referred to as a playlist. The media asset group can include one or a variety of different types of digital media assets. Examples of different types of digital media assets include, without limitation, music, videos, television shows, and podcasts. The web page can be associated with an entity or organization that has an interest or motivation to provide the media asset group. For example, the web page can be associated with an event, show, organization or place.

After the web page is presented on the display device associated with the client device 104, the user of the client device 104 can interact with the web page using various graphical user interface controls (e.g., virtual buttons, hyperlinks, etc.). As to the media asset group provided on the web page, the web page typically includes at least one graphical user interface control that enables the user to request a media asset group page from a media asset web server 108. Here, the client device 104 can interact with the media asset web server 108 via the network 106. The selection of the graphical user interface control on the web page from the affiliate web server 102 causes a request to be sent from the client device 104 to the media asset web server 108. The request includes media asset group information, such as attributes, that define the contents for the media asset group.

Upon receiving the request for the media asset group, the media asset web server 108 examines the incoming request and creates a media asset group web page in accordance with the media asset group information that is provided with the request. In doing so, the media asset web server 108 typically interacts with a media repository 110 to retrieve data pertaining to the media assets within the media asset group. For example, the media repository 108 can include at least a media database that stores at least metadata for a plurality of different media assets.

After the media asset group web page has been created, the media asset web server 108 can return the media asset group web page to the client device 104. The media asset group web page can then be presented to the user by the display device associated with the client device 104. The media asset group web page also includes one or more graphical user interface controls. At least one of the graphical user interface controls enables the user of the client device 104 to initiate a group acquisition request for all of the media assets within the media asset group. For example, the user of the client device can select a single user interface control to initiate purchase of the entire media asset group, i.e., all of the digital media assets within the media asset group.

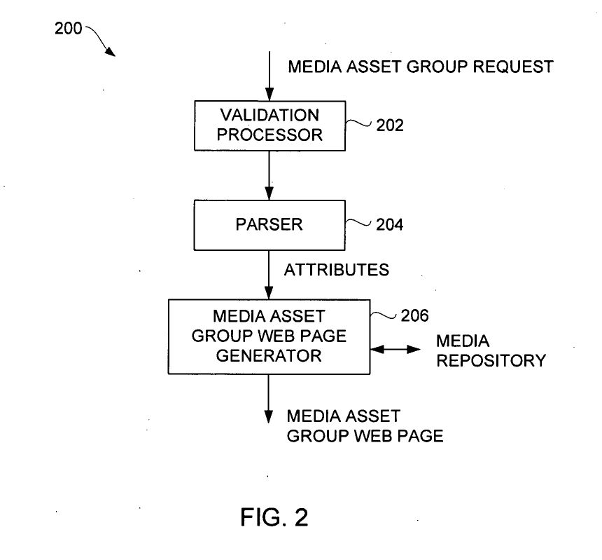

FIG. 2 is a block diagram of a media asset web server 200 according to one embodiment of the invention. The media asset web server 200 is, for example, suitable for use as one embodiment of the media asset web server 108 illustrated in FIG. 1.

The media asset web server 200 includes a validation processor 202, a parser 204 and a media asset group web page generator 206. The validation processor 202 receives an incoming media asset group request formulated to include media asset group information. The validation processor 202 evaluates at least a portion of the media asset group request to determine whether the request is valid. The validation checks being performed can validate the content of the request and/or the requester. In one implementation, the validation check can utilize a hashing algorithm to evaluate whether a hash value has been provided in the incoming media asset group request. If the media asset group request is determined to be valid, the validation processor 202 permits the parser 204 to examine the media asset group request. In particular, the parser 204 extracts the media asset group information provided with the media asset group request. More particularly, the parser 204 extracts a plurality of attributes associated with the media asset group that had been provided with the media asset group request. Next, the media asset group web page generator 206 can receive the attributes for the media asset group from the parser 204 and create a media asset group web page to be returned to the requester. In doing so, the media asset group web page generator 206 can access a media repository to retrieve data associated with the one or more media assets within the media asset group. The data being retrieved from the media repository can, for example, pertained to metadata associated with the media assets and/or graphical images associated with the media assets.

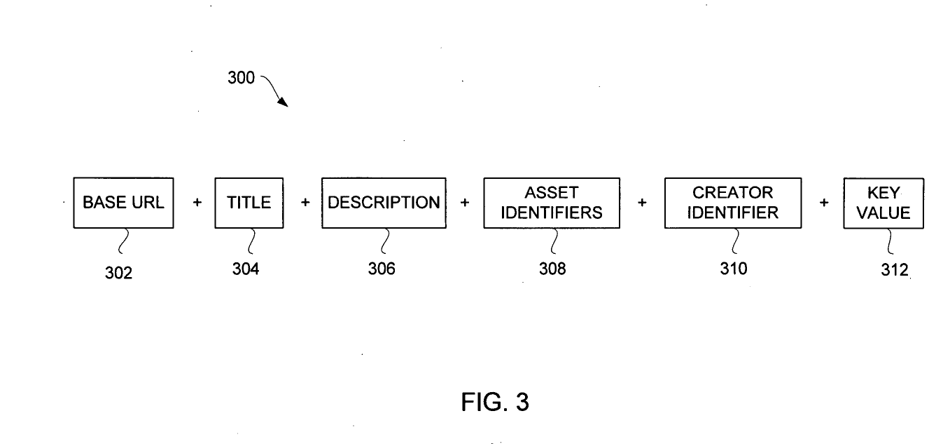

In one embodiment, the media asset group request can be implemented as a request URL provided as a link on a web page. FIG. 3 illustrates an exemplary configuration for a request URL 300 in accordance with one embodiment of the invention. The request URL 300 includes a base URL 302 which can be referred to as a path to a remote network location where a requested a media asset group page can be accessed and/or created. In addition, the request URL 300 can include a plurality of attributes, including a title 304, a description 306, asset identifiers 308, creator identifier 310 and a key value 312. The title 304 provides a title for the media asset group. The description 306 provides a brief description for the contents of the media asset group. The asset identifiers 308 is a listing of one or more asset identifiers for the one or more media assets that have been specified as being provided within the media asset group. The creator identifier 310 is a unique identifier assigned to a creator of the media asset group. As an example, only authorized persons can be provided with the creator identifiers. The key value 312 is an alphanumeric string that represents a hash value for the attribute portion of the request URL 300 and a shared secret. The shared secret is, for example, a string that is agreed to in advance by the requester and the media asset web server. In one implementation, the validation check can utilize a hashing algorithm to evaluate whether the key value 312 is from an authorized requester.

One example of an exemplary configuration for a request URL 300 is as follows:
http://itunes.com/webmix?title=My%20first%20mix&desc=A%20selection%20of%20hits%20handpicked%20for%20you&ids=78922868,148120908,257676472,215304964&wdId=1001&key=f69ebdd3f29f830a3a997780f3770937
   In this example, the title for the media asset group is “My first mix”; the description [desc] for the media asset group is “A selection of hits hand picked for you”; the asset identifiers [ids] for the media asset group are: “78922868,148120908,257676472,215304964”; the creator identifier [wdid] is “1001”; and the key is “f69ebdd3f29f830a3a997780f3770937”.

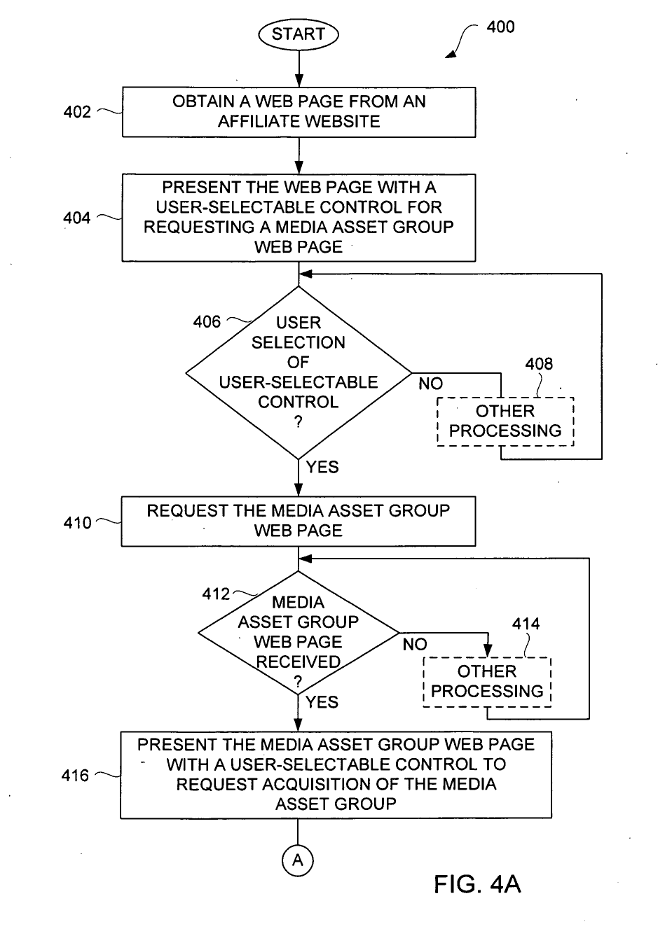

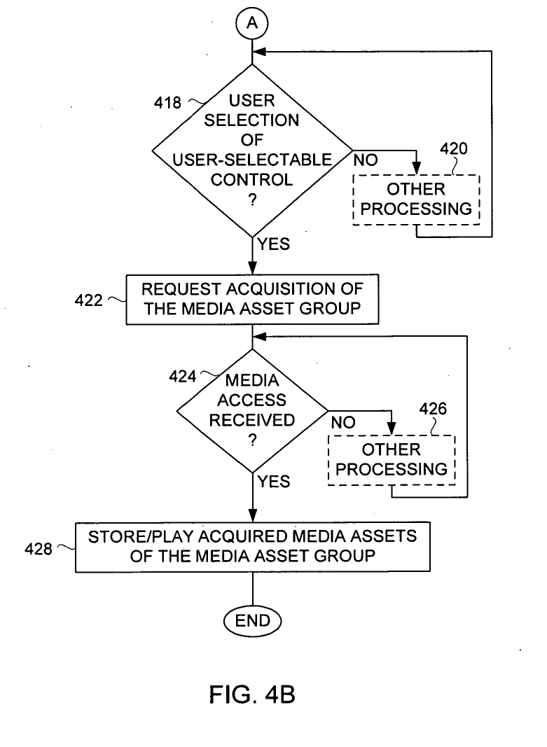

FIGS. 4A and 4B are flow diagrams of a client-side media access process 400 according to one embodiment of the invention. The client-side media access process 400 can, for example, be performed by the client device 104 illustrated in FIG. 1.

The client-side media access process 400 can initially obtain 402 a web page from an affiliate website. The web page can be presented 404 with a user-selectable control for requesting a media asset group web page. A decision 406 can determine whether a user selection of the user-selectable control has been received. When the decision 406 determines that a user selection of the user-selectable control has not been received, other processing 408 can be optionally performed while awaiting such a user selection. Alternatively, when the decision 406 determines that a user selection of the user-selectable control has been received, the media asset group web page can be requested 410.

Next, a decision 412 determines whether a media asset group web page has been received in response to the request 410. When the decision 412 determines that the media asset group web page has not been received, other processing 414 can be optionally performed while awaiting the receipt of the media asset group web page. Alternatively, when the decision 412 determines that a media asset group web page has been received, the media asset group web page can be presented 416. The media asset group web page can include a user-selectable control to request acquisition of the media asset group.

A decision 418 can then determine whether a user selection of the user-selectable control of the media asset group web page has been received. When the decision 418 determines that a user selection of the user-selectable control of the media asset group web page has not yet been received, other processing 420 can be optionally performed while awaiting a user selection of the user-selectable control. Alternatively, when the decision 418 determines that a user selection of the user-selectable control has been received, acquisition of the media asset group can be requested 422. The request 422 for acquisition of the media asset group can also be referred to as a media asset group acquisition request. Here, the acquisition being requested 422 is for the entire media asset group. In other words, all of the media assets within the media asset group can be acquired from the single user selection of the user-selectable control of the media asset group web page.

Next, a decision 424 can determine whether all of the media assets within the media asset group have been received. When the decision 424 determines that all of the media assets have not been received, other processing 426 can be optionally performed while awaiting the receipt of all of the media assets. Once the decision 424 determines that all of the media assets for the media asset group have been received, the acquired media assets of the media asset group can be stored and/or played 428 at the client device. Following the block 428, the client-side media access process 400 can end.

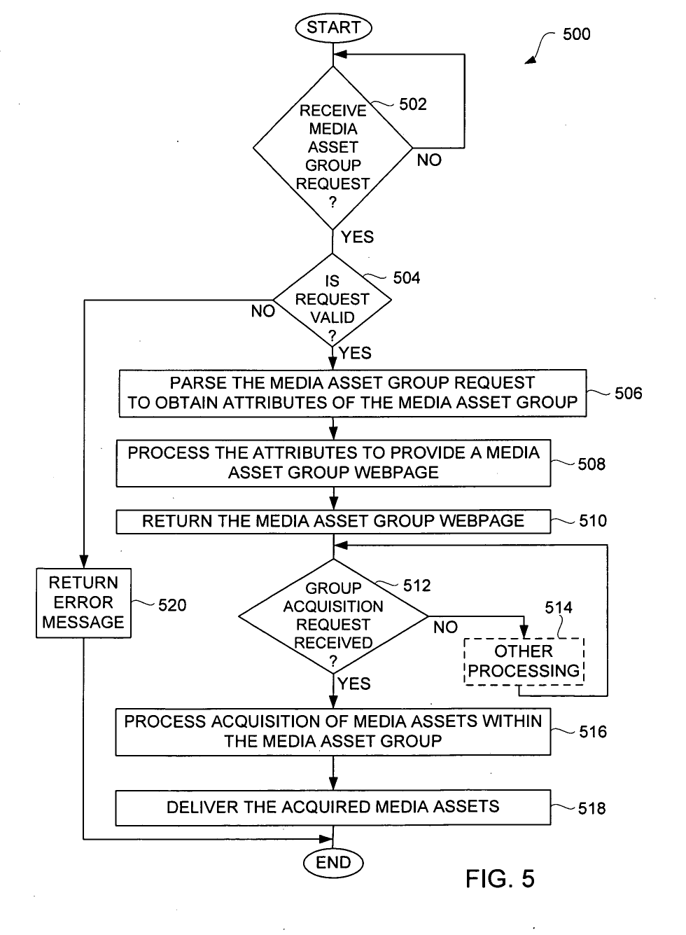

FIG. 5 is a flow diagram of a server-side media access process 500 according to one embodiment of the invention. The server-inside media access process 500 can, for example, be performed by the media asset web server 108 illustrated in FIG. 1.

The server-side media access process 500 can begin with a decision 502 that determines whether a media asset group request has been received. When the decision 502 determines that a media asset group request has not been received, the server-side media access process 500 awaits such a request. Once the decision 502 determines that a media asset group request has been received, a decision 504 can determine whether the media asset group request is valid. For example, the media asset group request can be evaluated to determine whether it is from an authorized requester. When the decision 504 determines that the media asset group request is valid, the media asset group request is parsed 506 to obtain attributes of the media asset group. Next, the attributes are processed 508 to provide a media asset group web page. Here, the media asset group web page can be dynamically created in accordance with the attributes provided with the media asset group request. The media asset group web page can then be returned 510 to the requester.

In one embodiment, the attributes can include a list of identifiers for the media assets to be included in the media asset group. Typically, different media providers will use different identifiers; hence, the identifiers can be specific to a media provider. Also, in some cases, an identifier for a media asset that is to be included within the media asset group pertains to a media asset that is, for whatever reason, not available from the media provider. For example, some media assets (e.g., songs, music videos) can only be purchased in an album; media items ineligible for purchase; or movies only available for rental (not purchase). In such cases, the processing to produce the media asset group web page can either indicate that such items cannot be purchased or remove such items from the media asset group. In one embodiment, the media asset group request can further include a flag to signal a user preference on how unavailable media assets are to be treated.

A decision 512 can determine whether a group acquisition request has been received. When the decision 512 determines that a group acquisition request has not been received, other processing 514 can be optionally performed while the server-side media access process 500 awaits receipt of a group acquisition request. Once the decision 512 determines that a group acquisition request has been received, acquisition of media assets within the media asset group can be processed 516. The acquired media assets can then be delivered 518 to the requester.

On the other hand, when the decision 504 determines that the media asset group request is not valid, the server-side media access process 500 can return 520 an error message to the requester. In such case, the requester does not receive a media asset group web page and thus cannot acquire media assets within a media asset group. Following the block 518 or the block 520, the server-side media access process 500 can end.

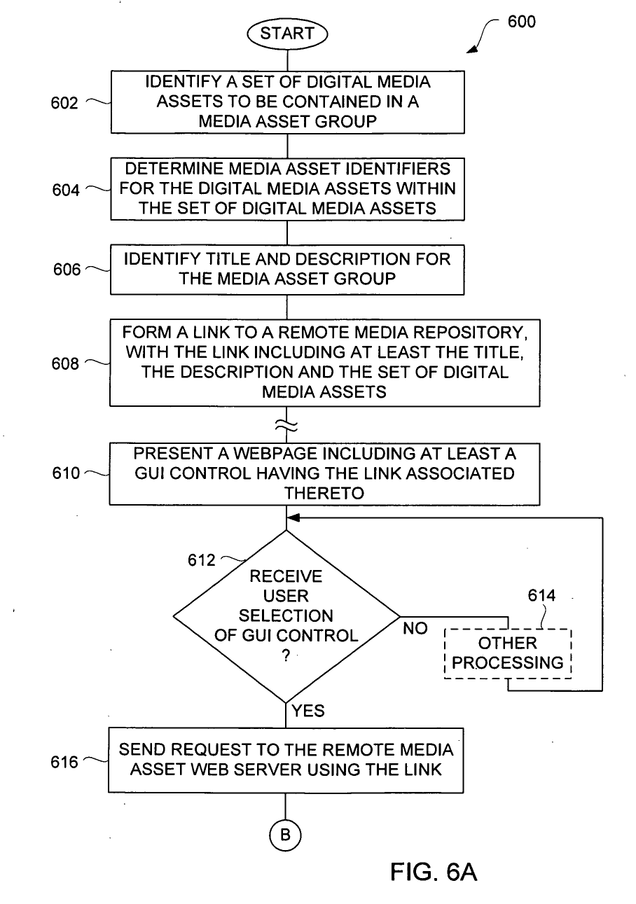

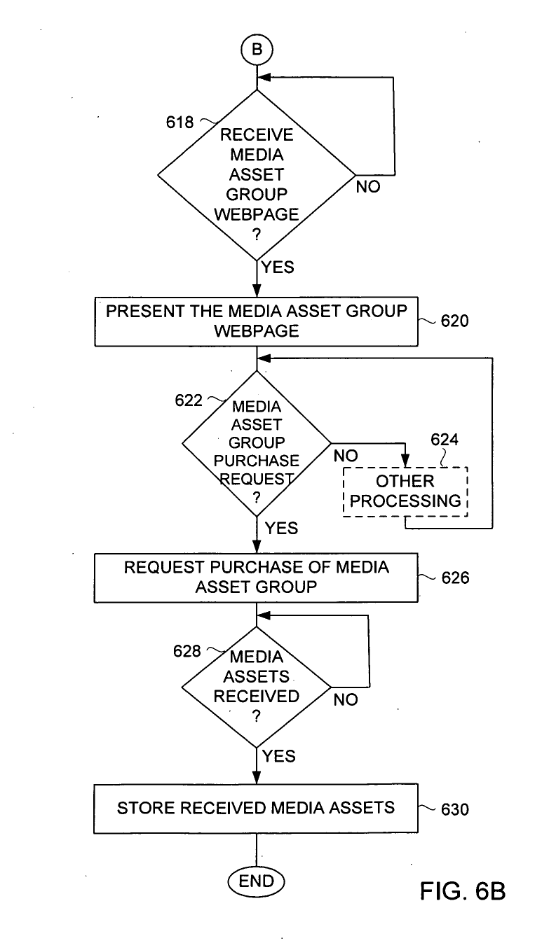

FIGS. 6A and 6B are flow diagrams of a media asset group acquisition process 600 according to one embodiment of the invention. The media asset group acquisition process 600 can identify 602 a set of digital media assets to be contained in a media asset group. In addition, media asset identifiers for the digital media assets within the set of digital media assets can be determined 604. Here, for example, the media asset identifiers can be identifiers assigned by media asset providers. For example, each media asset available from the iTunes™ store has a unique identifier associated with such media asset. Hence, for each of the digital media assets in the set of digital media assets, a media asset identifier can be determined 604 with reference to identifiers assigned by media asset providers. Media asset providers can provide tools or services that can be used to acquire the appropriate identifiers for particular media assets. As examples, Apple Inc. makes available an Enterprise Partner Feed to partners as well as a Web Service Search API and iTunes Link Maker that can enable links and/or appropriate identifiers for media assets to be acquired. In addition, a title and/or description for the media asset group can be identified 606.

Further, a link to a remote media repository can be formed 608. The link is, for example, a hyperlink or URL to a web page associated with the media asset group. The link can include not only a path to a media asset web server but also include at least the title, the description and the identifiers for the digital media assets. The set of digital media assets that are within the media asset group can be identified through use of the media asset identifiers that were determined 604. At this point, the link to the media asset web server can be utilized in one or more web pages and serve as a means to link from such one or more web pages to a remote media asset web server where detailed information pertaining to the media asset group can be obtained.

Accordingly, at some later point in time after the link has been formed 608, a web page including at least a graphical user interface control having the link associated thereto can be presented 610. A decision 612 can then determine whether a user selection of the graphical user interface control has been received. When the decision 612 determines that a user selection of the graphical user interface control has not been received, other processing 614 can be optionally performed while awaiting the receipt of a user selection of the graphical user interface control. On the other hand, when the decision 612 determines that a user selection of the graphical user interface control has been received, a request to the remote media asset web server can be sent 616 using the link.

A decision 618 can then determine whether a media asset group web page has been received in response to the request that has been sent 616. When the decision 618 determines that the media asset group web page has not been received, the media asset group acquisition process 600 awaits receipt the media asset group web page. Alternatively, when the decision 618 determines that the media asset group web page has been received, the media asset group web page can be presented 620. A decision 622 can then determine whether a media asset group purchase request has been received. When the decision 622 determines that a media asset group purchase request has not been received, other processing 624 can be optionally performed while the media asset group acquisition process 600 awaits such a media asset group purchase request. On the other hand, when the decision 622 determines that a media asset group purchase request has been received, purchase of the media asset group can the requested 626.

Next, a decision 628 can determine whether the media assets within the media asset group have been received. Here, in response to the purchase of the media asset group, each of the media assets within the media asset group is to be received. Hence, when the decision 628 determines that the media assets have not all been received, the media asset group acquisition process 600 can await receipt of all of the media assets. Once the decision 628 determines that all of the media assets have been received, the received media assets can be stored 630. Following the block 630, the media asset group acquisition process 600 can end.

This application also references and/or incorporates: (1) U.S. patent application Ser. No. 11/454,060, filed Jun. 14, 2006, and entitled “RATING MEDIA ITEM GROUPS”, which is hereby incorporated herein by reference; (2) U.S. patent application Ser. No. 11/114,914, filed Apr. 25, 2005, and entitled “PUBLISHING, BROWSING, RATING AND PURCHASING OF GROUPS OF MEDIA ITEMS”, which is hereby incorporated by reference herein; (3) U.S. patent application Ser. No. 11/115,090, filed Apr. 25, 2005, and entitled “PUBLISHING, BROWSING AND PURCHASING OF GROUPS OF MEDIA ITEMS”, which is hereby incorporated by reference herein; and (4) U.S. patent application Ser. No. 10/833,879, filed Apr. 27, 2004, and entitled “METHOD AND SYSTEM FOR SHARING PLAYLISTS”, which is hereby incorporated by reference herein.

The various aspects, features, embodiments or implementations of the invention described above can be used alone or in various combinations.

Embodiments of the invention can, for example, be implemented by software, hardware, or a combination of hardware and software. Embodiments of the invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

The advantages of the invention are numerous. Different embodiments or implementations may, but need not, yield one or more of the following advantages. One advantage of certain embodiments of the invention is that a remote web page identifying a group of items can provide a link to another web page where the group of items can be acquired. In one embodiment, the link can facilitate dynamic creation of a web page for the group of items. In one embodiment, the group of items is a group of media items. Another advantage of certain embodiments of the invention is that web pages for media assets groups can be dynamically generated and provided. In still another advantage of certain embodiments of the invention is that an interested user, by linking to a media asset group web page, can acquire all the media assets in the media asset group as a set.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer-implemented method for linking into a website, said method comprising:
(a) identifying a set of digital media assets to be contained in a media asset group;
(b) determining media asset identifiers for the digital media assets within the set of digital media assets;
(c) providing a title and a description for the media asset group;
(d) forming a link to a media repository, the link including at least the title, the description and the media asset identifiers for the media asset group;
(e) presenting a web page including at least a first graphical user interface control having the link associated thereto;
(f) receiving a user selection of the first graphical user interface control on the web page;
(g) accessing a remote server using the link when the graphical user interface control is selected;
(h) parsing the link of the remote server to obtain attributes of the media asset group;
(i) processing the attributes to provide a media asset group web page pertaining primarily to the media asset group; and
(j) presenting the media asset group web page, the media group web page providing a second graphical user interface control that facilitates acquisition of the digital media assets within the media asset group from the media repository.

2. A computer-implemented method as recited in claim 1, wherein the second graphical user interface control permits the media asset group to be purchased as an entire group.

3. A computer-implemented method as recited in claim 1, wherein with a single selection of the second graphical user interface control, the media asset group as the entire group is purchased.

4. A computer-implemented method as recited in claim 1, wherein the media asset group web page includes at least a graphical representation of the media asset group and a media asset listing identifying those of the digital media assets within the media asset group.

5. A computer-implemented method as recited in claim 1, wherein the link being formed further includes a security key and a creator identifier.

6. A computer-implemented method for accessing a media asset group on a client device, said method comprising:
obtaining a first web page from a first web site;
presenting the first web page, the first web page including at least a first user-selectable control having a URL request associated thereto;
receiving a user selection of the first user-selectable control;
issuing the URL request to a second web site for a media asset group web page;
receiving the media asset group web page; and
presenting the media asset group web page at the client device.

7. A computer-implemented method as recited in claim 6, wherein the media asset group includes a plurality of media assets being grouped together, and
wherein the media asset group web page includes at least a second user-selectable control used to initiate acquisition of the plurality of media assets grouped by the media asset group.

8. A computer-implemented method as recited in claim 7, wherein said method further comprises:
receiving a selection of the second user-selectable control; and
sending a media asset group acquisition request to a remote repository in response to the selection of the second user-selectable control.

9. A computer-implemented method as recited in claim 8, wherein said method further comprises:
receiving the plurality of media assets grouped by the media asset group from the remote repository; and
storing the media assets on the client device.

10. A computer-implemented method for providing access to a media asset group web page, said method comprising:
receiving a media asset group request from a requesting client device;
parsing the media asset group request to obtain attributes of the media asset group;
processing the attributes of the media asset group to produce a media asset group web page; and
sending the media asset group web page to the requesting client device.

11. A computer-implemented method as recited in claim 10, wherein said processing comprises:
validating the media asset group request prior to said processing,
wherein said processing is performed only if the media asset group request has been validated.

12. A computer-implemented method as recited in claim 10, wherein said processing comprises:
accessing a media resource using at least a portion of the attributes to acquire media asset data; and
generating the media asset group web page using the at least the portion of the attributes and the media asset data.

13. A computer-implemented method as recited in claim 10, wherein the media resource is a media repository and/or a media database.

14. A computer-implemented method as recited in claim 10, wherein the media asset group web page includes at least a user-selectable graphical user interface control used to initiate acquisition of a plurality of media assets associated with the media asset group.

15. A computer-implemented method as recited in claim 14, wherein said method further comprises:
receiving a group acquisition request to acquire the media assets associated with the media asset group.

16. A computer-implemented method as recited in claim 10, wherein the media asset group request comprises a URL request.

17. A computer-implemented method as recited in claim 16, wherein the URL request includes at least a base URL together with at least the attributes of the media asset group.

18. A computer-implemented method as recited in claim 17, wherein the attributes of the media asset group include at least a title and/or description, and a plurality of asset identifiers for the plurality of media assets included in the media asset group.

19. A computer-implemented method as recited in claim 18, wherein the attributes of the media asset group further includes at least a key value.

20. A computer-implemented method as recited in claim 18, wherein the attributes of the media asset group further includes at least a creator identifier.

21. A computer-implemented method as recited in claim 10, wherein said processing comprises filtering out those media assets from the media asset group that are not available for acquisition.

22. A method for forming a request URL for accessing a media asset group from a media repository, said method comprising:
providing a title and/or a description for the media asset group;
identifying a plurality of media assets to be included in the media asset group;
obtaining an asset identifier for each of the plurality of media assets to be included in the media asset group, the asset identifiers being unique identifiers with respect to media assets maintained by the media repository; and
forming the request URL from a base URL together with at least (i) the title and/or description, and (ii) the asset identifiers for the plurality of media assets to be included in the media asset group.

23. A method as recited in claim 22,
wherein said method further comprises:
generating a key value based on at least the title and/or the description for the media asset group along with the asset identifiers, and
wherein said forming of the request URL includes the key value within the request URL.

24. A method as recited in claim 23, wherein said generating of the key value uses a hash function to generate the key value.

25. A method as recited in claim 22,
wherein said method further comprises:
providing a creator identifier pertaining to a creator of the request URL, and
wherein said forming of the request URL includes the creator identifier within the request URL.

26. A method as recited in claim 25,
wherein said method further comprises:
generating a key value based on at least the title and/or the description for the media asset group along with the asset identifiers and the creator identifier, and
wherein said forming of the request URL includes the key value within the request URL.

27. A method as recited in claim 22,
wherein said method further comprises:
providing a processing indicator to indicate whether to perform a particular process with respect to the media asset group at a remote server, and
wherein said forming of the request URL includes the processing indicator within the request URL being formed.

28. A method as recited in claim 27, wherein the particular process to be performed removes those one or more of the media assets in the media asset group that are not available from the media repository.
